(19) United States
(12) Patent Application Publication
(10) Pub. No.: US 2006/0065693 A1
(43) Pub. Date: Mar. 30, 2006

(54) Multi-purpose nail driver

(76) Inventor: John Wayne Eklund, Barrie (CA)

Correspondence Address: John Eklund, Box 146, ORO, ON, LOL 2XO, CA

(21) Appl. No.: 11/235,135

(22) Filed: Sep. 27, 2005

Related U.S. Application Data
(60) Provisional application No. 60/613,591, filed on Sep. 28, 2004.

(30) Foreign Application Priority Data
Sep. 15, 2004 (CA) 2479745

(51) Int. Cl. B25C 7/00

(52) U.S. Cl. 227/147

(57) ABSTRACT

A nail driving attachment for an air hammer has an elongated body adapted for attachment to an air hammer and a striker face positioned at a remote end of the body. A retractable sleeve overlies the remote end of the body and extends past the striker face, such that the retractable sleeve provides a tubular channel which confines an individual nail being driven and serves to keep the nail in substantial axial alignment with the body.

### FIELD OF THE INVENTION

The present invention relates to a nail driving attachment which is used with an air hammer to drive nails.

### BACKGROUND OF THE INVENTION

There currently exist air hammers that are capable of driving nails.

### SUMMARY OF THE INVENTION

According to the present invention there is provided a novel nail driving attachment for an air hammer. This tool relates to driving nails by attaching the tool to a standard air hammer. The concept is to use the rapid striking force of the air hammer to drive the nail. Thereby eliminating the need for a forming or manual hammer. The striker face of this tool is held in alignment with the nail head by means of a spring loaded retractable sleeve.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a side elevation of a nail driving attachment for an air hammer constructed in accordance with the teachings of the present invention.

FIG. 2 is an exploded side elevation view, partly in section, of the nail driving attachment for an air hammer illustrated in FIG. 1.

### DETAILED DESCRIPTION OF THE PREFERRED EMBODIMENT

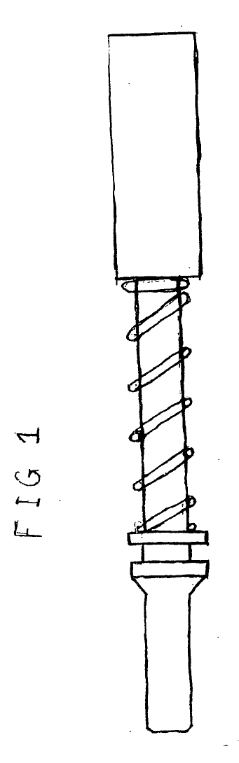

Referring to FIG. 1, there is illustrated a nail driving attachment that goes into an air hammer for the purpose of driving nails. Unlike common air nailers this tool uses loose or non-attached nails. Each nail is fed by hand into the nailer. The nail head is held in alignment with the striker face by means of a retractable sleeve. The punch and striker has a universal base to fit all standard air hammers. The striker face has a width of 9/16 inch. The retractable sleeve is spring loaded and slides over the striker and is withdrawn as the nail enters the wood. The unit will drive any nail with a head of less than 9/16 inch and any nail with a length over 1¼ inch.

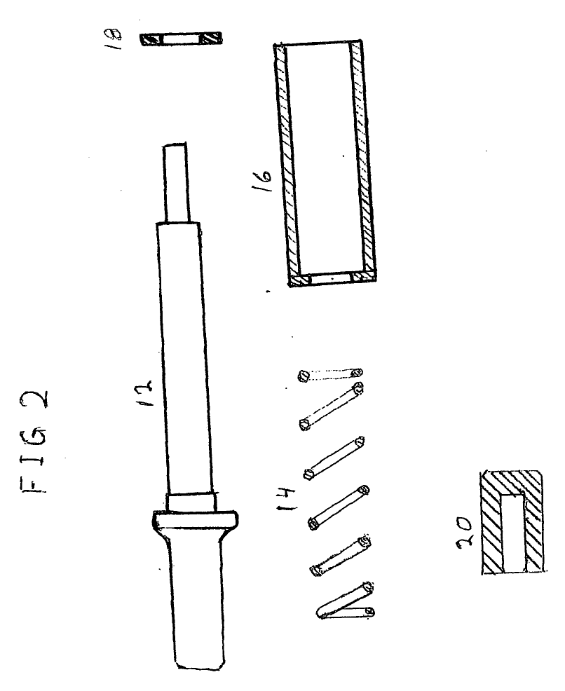

Referring to FIG. 2, the components of the nail driving attachment include a punch body 12. A spring 14 overlies body 12 and provides a biasing force to a retractable sleeve 16. A washer 18 limits upward movement of spring 14 along body 12. A striker plate 20 is positioned at a remote end of body 12. Retractable sleeve 16 extends past remote end of body 12 and provides a tubular channel which confines a nail being driven and serves to keep the nail in substantial axial alignment with the body.

What is claimed is:

1. A nail driving attachment for an air hammer, comprising:
an elongated body adapted for attachment to an air hammer;
a striker face at a remote end of the body;
a retractable sleeve overlying the remote end of the body and extending past the striker face, such that the retractable sleeve provides a tubular channel which confines an individual nail being driven and serves to keep the nail in substantial axial alignment with the body.
